(19) United States
(12) Patent Application Publication
(10) Pub. No.: US 2009/0226291 A1
(43) Pub. Date: Sep. 10, 2009

(54) Freight loading system

(75) Inventor: Willi Kranz, Bremerhaven (DE)

Correspondence Address: VENABLE LLP, P.O. BOX 34385, WASHINGTON, DC, 20043-9998, US

(73) Assignee: Rheinmetall Defence Electronics GmbH, Bremen (DE)

(21) Appl. No.: 11/919,933

(22) PCT Filed: Feb. 15, 2006
(86) PCT No.: PCT/EP2006/001348

§ 371 Date: Jan. 26, 2009

(30) Foreign Application Priority Data
May 6, 2005 (DE) 10 2005 021 078.3

(51) Int. Cl. B60P 1/52

(52) U.S. Cl. 414/529

(57) ABSTRACT

Freight loading system in an aeroplane or another transportation vehicle, with floor-conveying elements (6) which are capable of rotating items of freight about an axis perpendicular to the loading surface (12), with floor-conveying elements (6, L1, L2, L3, xL1, xL2, xL3, T1, T2) which are arranged in the loading surface and have fixedly oriented, bi-directional conveying capability, and a control device which, in order to rotate the items of freight, activates floor-conveying elements which are arranged essentially on a curved track.

### TECHNICAL FIELD

The invention relates to a freight loading system, used in an airplane or another type of transport vehicle, with floor conveying elements that are capable of rotating freight items around an axis, perpendicular to the loading surface.

### PRIOR ART

When loading and unloading the cargo space of a transport means, it is often necessary to rotate a freight item, for example in the form of a pallet or a container, to make optimum use of the available cargo space. There are some airplanes for which the loading hatch is arranged on the side of the airplane fuselage, for example, wherein the dimensions this loading hatch only insignificantly exceed the dimensions for the smallest side surface of the largest possible freight item. A rotating of the freight item is therefore necessary, especially if the cargo space is not uniform over its total length, which is often the case with airplanes where the cargo space is tapered in the area of the landing gear. The freight items are consequently rotated in the plane for the loading surface, meaning they are rotated around an axis (upright axis) that is positioned perpendicular to the loading surface.

The German Patent document DE 31 02 146 C2, for example, discloses an arrangement that forcibly redirects freight pallets and/or containers. For this, a pivoting pin is arranged in the area of the cargo space door of an airplane, which engages in a fitting that is attached to the pallet and/or container and can be folded out. The disadvantage of this arrangement is that each freight item to be rotated must be provided with an additional fitting. On the one hand, this involves a higher financial and technical expenditure and, on the other hand, it increases the transport weight.

According to the U.S. Pat. No. 4,050,655, the freight item is rotated by being pushed with the aid of roller conveyors against an end stop that is located in the region of the cargo space door. The roller conveyors can thus rotate in the plane for the loading surface and are oriented differently, depending on the operating mode. Roller conveyors of this type have the disadvantages of being heavier, more expensive, and requiring higher maintenance than non-rotating roller conveyors.

### REPRESENTATION OF THE INVENTION

It is therefore the object of the present invention to provide an improved freight loading system, which does not have the aforementioned disadvantages of the systems according to prior art.

This object is solved by rotating the freight items with the aid of fixedly oriented floor conveying elements that already exist in the freight loading system. For this, the freight loading system is provided with at least one control device, which activates floor conveying elements for rotating the freight items, wherein these elements are essentially arranged along a curved track.

The floor conveying elements have a fixedly oriented, bi-directional conveying capacity, meaning they can convey in two opposing directions, which allows switching between the conveying directions. The straight line along which a conveying element can convey is determined during its installation and cannot be changed during the operation, meaning the floor conveying element has a fixed orientation.

Existing freight loading systems are normally provided with floor conveying elements of the aforementioned type, in the form of so-called PDU's (power drive units). These are short, driven roller conveyors with a fixedly oriented axis of rotation.

The PDU's are normally arranged inside a cargo space in such a way that their conveying directions are orthogonal to each other, meaning they are for the most part oriented in longitudinal and lateral direction of the cargo space in order to transport a freight item in longitudinal or lateral direction of the loading surface. PDU's are frequently designed so as to move up and down and can be lowered to prevent obstructing a movement of the freight item in a direction other than the PDU conveying direction.

According to the invention, some of these fixedly oriented PDU's are used for rotating a freight item. The control device for activating the PDU's is therefore provided with an additional operating mode for the rotational function. The information specifying the PDU's to be activated for the respective rotational direction of the freight item and the respective conveying direction of the individual PDU's is therefore stored in the control device. The PDU's, which are activated for rotating the freight item, are essentially arranged along a curved track, thereby reconstructing the trajectory of the freight item to be rotated. The floor conveying elements, for which the direction is as tangential as possible to the curved track, are advantageously activated for rotating the freight item. The statement “substantially along a curved track” preferably encompasses not only the floor conveying elements, which are positioned precisely or approximately on this curved track, but alternatively also the adjacent floor conveying elements having the same conveying direction.

The freight loading system preferably has an end stop around which the freight item is rotated. This end stop can be an edge of the cargo space door, for example, or a separate device.

The freight loading system according to the invention has the advantage that the rotational functionality can be realized with just a few changes made to an existing freight loading system. Existing freight loading systems normally comprise fixedly oriented floor conveying elements for moving the freight items in longitudinal and lateral direction. The rotating function is realized according to the invention by purposely activating some of the existing floor conveying elements. The use of additional or modified floor conveying elements is not necessary. In addition, the delay resulting from a new orientation of the floor conveying elements is avoided.

The freight loading system is operated with standard control panels, which are equipped with different operating elements for utilizing the different functionalities. For example, a freight item is frequently navigated with the aid of a joystick. A control panel can furthermore be provided with display devices, for example for displaying the system status. Operating consoles of this type are either installed fixedly on location or are embodied such that they can be used flexibly at different locations by the operating personnel, by linking them via cable or wireless connection to the freight loading system.

The freight loading system according to the invention preferably comprises at least one control panel, provided with an operating element for controlling the rotation of a freight item. This operating element can be a switch, a scanner, or another type of input device. It is also possible to expand an existing operating element to take on the function of controlling the rotation, thereby ensuring an easy operation of the freight loading system according to the invention.

The freight loading system according to the invention is primarily used in an airplane, but can also be used for other transport means, such as trains or ships. Freight items destined for airplanes, in particular, primarily take the form of (standardized) containers or pallets.

### SHORT DESCRIPTION OF THE DRAWING

The invention is to be explained further with the aid of an exemplary embodiment, showing in:

FIG. 1 An arrangement of floor conveying means for a freight loading system.

### WAYS AND MEANS OF REALIZING THE INVENTION

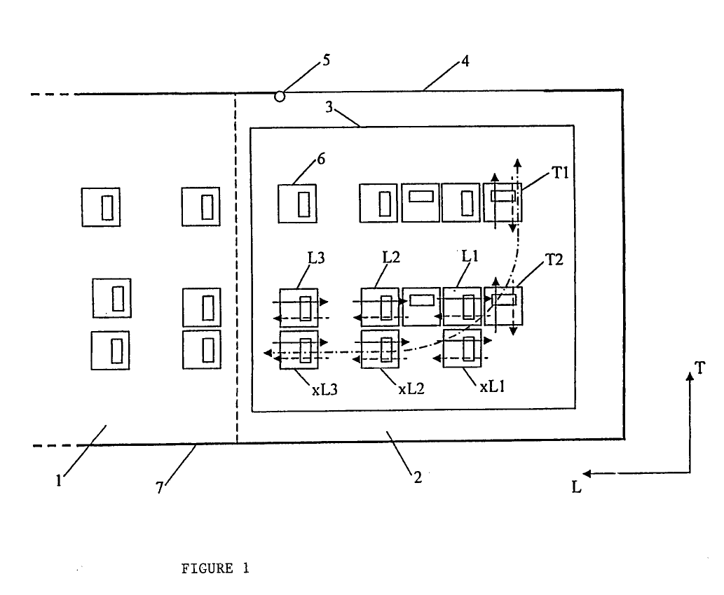

FIG. 1 shows a basic diagram of a section of a cargo space 7 for an airplane. The loading area 2, which is provided with ball mats in one section 3, is located in the region of the cargo space door 4. Ball mats of this type serve to hold the weight of a freight item while simultaneously ensuring maneuverability and are known to one skilled in the art in connection with freight loading systems. For the transport, the freight items are deposited in the region 1. A few floor conveying elements 6 are shown herein as examples, wherein these are installed in the loading surface and are preferably roller conveyors. Roller conveyors of this type are also referred to as PDU's (power drive unit). The PDU's preferably are embodied or mounted such that they can be lowered, thus preventing inactive PDU's from obstructing the desired movement of the freight item. The PDU's for the present example are oriented such that their conveying directions extend along the longitudinal axis L or the lateral axis T of the airplane and thus the loading surface, meaning they are positioned perpendicular to each other which corresponds to the standard configuration for freight loading systems.

The freight item is rotated during the movement into and/or out of the loading area 2. A rotation outside of the cargo space 7 is generally not possible since the freight item would then have to be moved with its longitudinal side through the cargo space door 4. This would require a cargo space door having a specific minimum size, which cannot be realized for technical reasons. In particular standardized containers can be long enough so that it is also not possible to transport the freight item with the front side through the cargo space door 4 and to turn it completely inside the loading area 2. The freight item is therefore preferably located partially inside the cargo space 7 and partially outside of it during the rotation.

For the present example, the eight PDU'S, L1, L2, L3, xL1, xL2, xL3, T1 and T2, are used for rotating the freight item. The continuously drawn arrows indicate the conveying direction of the respective PDU when the freight item is rotated out of the cargo space 7, while the dashed arrows indicate the conveying direction when the freight item is rotated into the cargo space 7. The dash-dot arrow illustrates clearly that the PDU's L1, L2, L3, xL1, xL2, xL3, T1 and T2, which are used for the rotation, are essentially arranged along a curved track.

The rotating of a freight item into the cargo space 7 is described in the following, wherein at least a portion of the freight item is initially moved through the cargo space door 4 and into the loading area 2. The command for rotating the freight item into this space is then issued, whereupon the control device activates the PDU's L1, L2, L3, xL1, xL2, xL3, T1 and T2, which convey in the direction of the dashed arrows, while the remaining PDU's 6 are deactivated. In FIG. 1, the PDU's L1, L2, L3, xL1, xL2, xL3 move the freight item to the left until it hits the end stop 5. A moment is thus generated between the force of the PDU's and the counter-force at the end stop 5, which causes the freight item to be rotated in clockwise direction into the cargo space 7. The rotation occurs around an axis that is positioned perpendicular on the loading surface plane. The rotational movement is supported by the PDU's T1 and T2, which is advantageous especially with heavy freight items and/or a loading surface that is not oriented completely horizontal. The transport inside the area 1 is then handled by the PDU's arranged therein. The rotating out operation occurs in an analog manner, wherein the PDU's T1 and T2 are instrumental in generating the moment around the end stop 5 and are supported by the PDU's L1, L2, L3, xL1, xL2, xL3.

When using an operating panel for a freight loading system, which is known per se, a joystick can be used for the translatory movement of the freight item. At the position “IN” and/or “OUT,” the freight item is moved along the transverse axis T through the cargo space door 4 into the loading area 2 and/or out of the loading area 2. The positions “AFT” and/or “FWD” are used for moving the freight item along the longitudinal axis L of the airplane. The operating panel 10 preferably comprises an operating element for controlling the rotation of the freight item. According to one embodiment, this is a switch comprising in addition to the center setting “Turn in” for rotating the freight item into the cargo space 7 the setting “Turn out” for rotating the freight item out of the cargo space 7. The switch preferably locks in place when it is in the center position and automatically returns to the center position from the other positions if it is not activated. A joystick can be used as alternative to a switch for controlling the rotational movement in addition to the translatory movement of the freight item. This can be achieved, for example, through a rotation of the joystick shaft around its longitudinal axis in clockwise direction or counter to the clockwise direction.

The above-described embodiment is purely exemplary and not restrictive. In particular, the general number and arrangement of the floor conveying elements can vary, as well as the selection of the floor conveying elements that are activated for the rotation. Besides roller conveyors, other types of floor conveying elements such as belt conveyors can also be used. The conveying directions of the floor conveying elements furthermore do not need to be perpendicular to each other or extend along the longitudinal and/or transverse axis.

1-6. (canceled)

7. A freight loading system used in an airplane or another type of transport vehicle, with floor conveying elements with fixedly oriented bi-directional conveying capacity, which are arranged in the loading surface and are capable of rotating freight items around their axis, perpendicular to the loading surface and with a control device for activating floor conveying elements for rotating the freight items, wherein the floor elements are essentially arranged along a curved track, further comprising an end stop around which the freight item is rotated.

8. The freight loading system according to claim 1, wherein the floor conveying elements are oriented such that their conveying directions are perpendicular to each other and, in particular, extend in longitudinal and lateral direction of the loading surface.

9. The freight loading system according to claim 1 wherein the floor conveying elements are roller conveyors.

10. The freight loading system according to claim 1, wherein the floor conveying elements used for the rotation are arranged inside of the cargo space, in the region of the cargo space door.

11. An operating console for a freight loading system according to claim 1, further comprising an operating element for controlling the rotation of a freight item.
